(19) United States
(12) Patent Application Publication
(10) Pub. No.: US 2026/0017564 A1
(43) Pub. Date: Jan. 15, 2026

(54) EFFICIENT ADAPTATION OF MACHINE LEARNING MODELS

(71) Applicant: QUALCOMM Incorporated, San Diego, CA (US)

(72) Inventors: Amr Mamoun MARTINI, San Diego, CA (US); Arvind Vardarajan SANTHANAM, San Diego, CA (US); Christopher LOTT, San Diego, CA (US)

(21) Appl. No.: 18/968,760

(22) Filed: Dec. 4, 2024

Related U.S. Application Data
(60) Provisional application No. 63/669,065, filed on Jul. 9, 2024.

(51) Int. Cl. G06N 20/00; G06N 3/02

(52) U.S. Cl. CPC G06N 20/00; G06N 3/02

(57) ABSTRACT

Techniques and apparatus for efficiently adapting a machine learning model to perform tasks using adapters are provided. An example method generally includes receiving an input for processing by a transformer block in a neural network. An output of the transformer block is generated based on the received input and weights associated with the transformer block. An output of an adapter associated with the transformer block is generated based on a copy of the received input and adapter weights associated with the adapter. Key-value data associated with the output of the transformer block and key-value data associated with a combination of the output of the transformer block and the output of the adapter are stored in a cache for subsequent inferencing rounds. A response to the input is generated based on the combination of the output of the transformer block and the output of the adapter.

### CROSS-REFERENCE TO RELATED APPLICATION(S)

This application claims the benefit of and priority to U.S. Provisional Application No. 63/669,065, filed Jul. 9, 2024, which is assigned to the assignee hereof and hereby expressly incorporated by reference in its entirety as if fully set forth below and for all applicable purposes.

### INTRODUCTION

Aspects of the present disclosure relate to machine learning models.

Machine learning models can be used to perform various tasks, such as tasks based on computer vision, natural language processing, audio processing, and the like. Single-purpose models may be trained to perform a specific task. For example, in some autonomous driving scenarios, different models may be trained to perform semantic segmentation (e.g., to divide visual content into different regions corresponding to different types of objects), object detection, motion prediction, and the like. In other examples, generative artificial intelligence models may be trained to generate responses to queries from different data domains. In such cases, one model may be trained to generate responses based on a general knowledge database, and other models may be trained to generate responses based on domain-specific knowledge databases.

Training and maintaining multiple machine learning models to perform related tasks may be computationally expensive. Thus, to reduce the computational expense of maintaining multiple models, various techniques can be used to adapt a model (e.g., a pre-trained large language model (LLM)) to perform a variety of downstream tasks. For example, in transfer learning, machine learning models pre-trained on large-scale datasets can leverage the knowledge obtained from one dataset to perform a different but related task (e.g., transferring classification-related knowledge for classifying one type of object to classifying a different type of object in image data). To perform transfer learning, portions of the machine learning model can be finetuned in order to adjust a pre-trained model for a downstream task different from the original, or source, task for which the model was trained. Finetuning the machine learning model generally produces a separate copy of the pre-trained model parameters for each task.

Although generating different versions of the pre-trained model parameters for different tasks may be a useful approach, efficiency may decrease as the number of downstream tasks for which a model is trained increases. Such finetuning may be computationally expensive, leading such models to be impractical or infeasible to deploy on resource-constrained systems (e.g., edge devices, such as mobile phones or other computing devices with limited computational and/or memory capabilities).

### BRIEF SUMMARY

Certain aspects provide a processor-implemented method for efficiently adapting a machine learning model to perform a variety of tasks using adapters. The method generally includes receiving an input for processing by a transformer block in a neural network. An output of the transformer block is generated based on the received input and weights associated with the transformer block. An output of an adapter associated with the transformer block is generated based on a copy of the received input and adapter weights associated with the adapter. Key-value data associated with the output of the transformer block and key-value data associated with a combination of the output of the transformer block and the output of the adapter are stored in a cache for subsequent inferencing rounds. A response to the input is generated based on the combination of the output of the transformer block and the output of the adapter.

Certain aspects provide a processor-implemented method for efficiently adapting a machine learning model to perform a variety of tasks using different adapters. The method generally includes receiving an input including a sequence of tokens associated with at least an input prompt into a neural network, the sequence of tokens being generated by a transformer block and a first set of adapters associated with the transformer block. A second set of adapters associated with the transformer block is loaded. An output of the transformer block is generated based on a key-value cache associated with the input and on weights associated with the transformer block. An output of the second set of adapters associated with the transformer block is generated based on the key-value cache associated with the input and on adapter weights associated with the second set of adapters.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and apparatus comprising means for performing the aforementioned methods as well as those further described herein.

The following description and the related drawings set forth in detail certain illustrative features of one or more aspects.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 depicts an example of efficient adaptation of a machine learning model, in accordance with aspects of the present disclosure.

FIG. 2 illustrates an example pipeline for generating a response to an input prompt using a machine learning model with adapters, in accordance with aspects of the present disclosure.

FIG. 3 illustrates example operations for inferencing using a machine learning model adapted from a base model to perform a downstream task, in accordance with aspects of the present disclosure.

FIG. 4 illustrates example operations for inferencing using a machine learning model adapted from a base model to perform tasks using different loadable adapters, in accordance with aspects of the present disclosure.

FIG. 5 illustrates an example system on which aspects of the present disclosure may be executed, in accordance with aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for efficiently adapting machine learning models using batch processing techniques.

Machine learning models may be trained and deployed to perform various tasks, such as computer-vision-related tasks, natural language processing, and audio processing and/or analysis, with machine learning models pre-trained on large-scale datasets to leverage the knowledge gained while training a machine learning model to perform an initial task. In some cases, these machine learning models may include various generative models, such as large language models used in generating natural language responses to natural language prompts and other generative models used in generating content in response to a prompt. Generally, these models may be trained to perform a base task, and subsequently, the trained base model may be adapted to perform various downstream tasks. Such adaptation may be performed using various finetuning techniques that update the parameters of the trained base model in order to allow the model to perform a downstream task that is different from, but related to, the base task for which the base model was trained (e.g., finetuning a generative artificial intelligence model trained to generate responses to general knowledge prompts to allow the finetuned model to generate responses to domain-specific prompts). Generally, finetuning the layers produces a separate copy of the pre-trained model parameters for each task, while finetuning the last classification layer may reduce the computational expense of transfer learning at the expense of inference performance on downstream tasks (e.g., tasks other than the original task for which the machine learning model was trained). In some cases, adaptation may be performed using adapter layers inserted into a machine learning model.

In some aspects, a base machine learning model and task-specific adapters may be used to allow an application to perform various tasks using the machine learning model. When a context shift occurs, it may be determined that a first adapter previously used to respond to inputs into the machine learning model may be substituted for a second, more relevant adapter. However, when switching adapters from a first adapter to a second adapter, contextual information (e.g., data in a key-value cache) generated using the first adapter may not be usable by the second adapter. For example, the adapted weights of the machine learning model using the first adapter and the contextual information usable by the first adapter may be irrelevant to or incompatible with the second adapter. Thus, in order to generate a response to the input, the second adapter may reprocess the input in order to generate the proper context for responding to the query. This reprocessing of the input may incur a significant processing overhead (in terms of processing cycles, power utilization, memory overhead, and the like).

Certain aspects of the present disclosure provide techniques for efficiently adapting a machine learning model to perform a variety of tasks using loadable adapters and preservation of key-value cache data that is usable across different adapters. As discussed in further detail herein, a base machine learning model (such as a neural network) and an adapter may operate in parallel using batch processing techniques, resulting in the generation of an output including data generated by the base machine learning model and data generated by the adapter associated with the base machine learning model. To generate a response to an input query, outputs may be generated based on the data generated by the adapter, and these outputs may be appended to the input and a copy of the input (which may be used by the base machine learning model and the adapter to generate subsequent responses). When a context switch occurs, a second adapter may be loaded, and subsequent response generation may be performed based on the inputs and cached data associated with the base machine learning model. By doing so, the second adapter may generate responses to the input without reprocessing the input, which may allow for inferencing operations to be performed using fewer computing resources (e.g., processing cycles, power, etc.) than would be used by finetuned models adapted to the same downstream task.

### Example Efficient Adaptation of Machine Learning Models

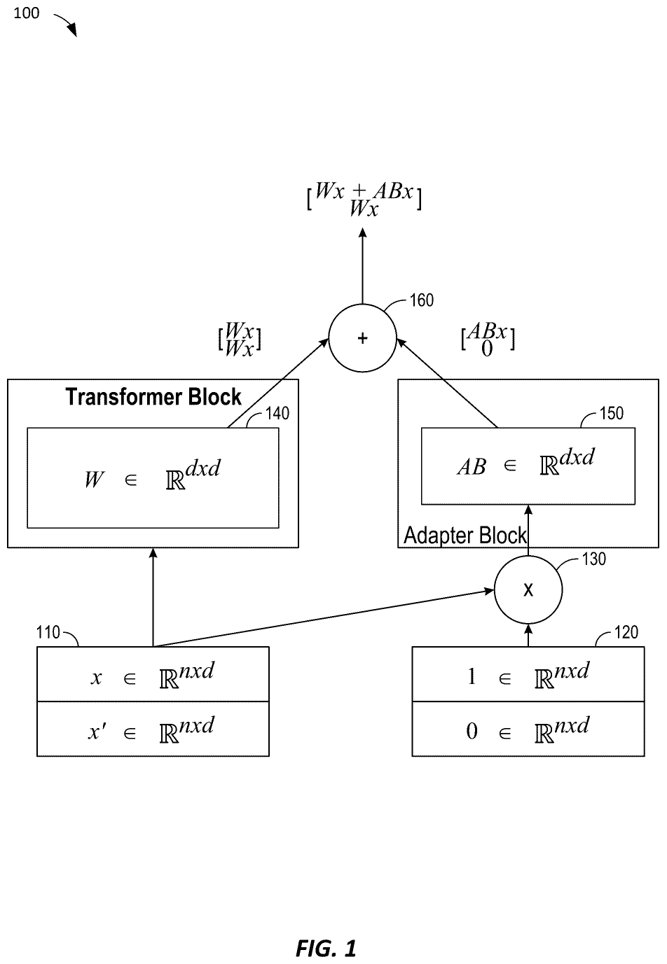

FIG. 1 illustrates an example of efficient adaptation of a machine learning model 100 using batch processing, according to aspects of the present disclosure.

The machine learning model 100 generally includes one or more layers, each of which may be associated with a set of parameters (e.g., weights) generated while training the machine learning model to perform a base task. For example, as discussed above, if the machine learning model 100 is a large language model (LLM) trained to generate answers to general knowledge questions, the downstream task for which the machine learning model 100 is trained may include the generation of domain-specific responses to domain-specific questions. While the machine learning model 100 illustrates a single layer that receives an input x and generates an output h, it should be recognized that a machine learning model may include any number of layers which may be independently adapted to perform a downstream task.

Generally, as illustrated, the machine learning model 100 includes a set of pretrained weights W 140, represented by the expression W∈ [symbol] ^{k×d}, where d corresponds to a dimension of the input x∈ [symbol] ^{d×n}, n corresponds to a number of tokens in the input, and k corresponds to a number of keys included in the machine learning model 100 (e.g., where the machine learning model 100 implements a transformer architecture in which an output is modeled based on key data, value data, and query data). To generate an output h for the base task for which the machine learning model 100 is trained, the machine learning model 100 can apply the pretrained weights 140 to the input x. For example, the output h, having dimensions of k×n, may be represented by the equation:

$$h = Wx$$

To allow the machine learning model 100 to perform a downstream task that is different from, but related to, the base task for which the machine learning model is trained, adapter weights 150, including learnable matrices A and B, may be trained based on data associated with the downstream task. Meanwhile, the pretrained weights 140 may be frozen (e.g., fixed after training the machine learning model 100) to constrain learning (or updating) to learnable matrices A and/or B. The constraints on updating the pretrained weights 140 may be performed by representing the updates to the pretrained weights 140 to a low-rank decomposition, such that the weights associated with the downstream task are represented by the pretrained weights 140 and a delta weight ΔW=AB. Thus, the output h for the downstream task for which the machine learning model is adapted may be represented by the equation:

$$h = Wx + Δ Wx = Wx + ABx$$

Generally, the adapter weights 150, defined as the learnable matrices A and B, may be low-rank matrices that allow for changes in the weights of the machine learning model 100 to be projected into a smaller subspace. For example, the first learnable matrix A may be represented by the expression A∈ [symbol] ^{r×k}, and the second learnable matrix B may be represented by the expression B∈ [symbol] ^{d×r}, where r represents the rank of these matrices and r<<min (d, k). In some aspects, the learnable matrix A may be initialized as a random matrix (e.g., using Gaussian initialization), and the learnable matrix B may be initialized as a matrix with all zero values, such that ΔW=AB=0 before the machine learning model 100 is adapted to perform a downstream task. During adaptation to generate values in the matrices A and B that adapt the pretrained weights 140 from the weights associated with a base task to the adapter weights 150 associated with a downstream task, ΔWx may be scaled by the factor α/r, where α is constant in r. In some aspects, tuning α may adjust the learning rate and may be set to the first value of r used in adapting the machine learning model 100 so that the hyperparameters of the machine learning model 100 need not be retuned as r is adjusted.

Generally, the adaptation of the machine learning model 100 using adapters associated with the adapter weights 150 allows for the machine learning model 100 to be flexibly deployed to perform a variety of downstream tasks using a variety of adapters which may be loaded and unloaded as the context in which the machine learning model operates changes. Further, because the architecture of the machine learning model 100 remains unchanged, inferencing operations for the base task for which the machine learning model 100 is trained and the downstream tasks for which the machine learning model is adapted may be performed with minimal or no increases in inference time (and corresponding computing resource utilization, such as processor time, memory utilization, power, etc.). However, as discussed above, context switching between different adapters may incur a significant processing overhead, as a newly loaded adapter typically is unable to leverage the context used by the unloaded adapter in generating subsequent responses to the input query. Thus, the newly loaded adapter generally re-processes the input and tokens or other outputs generated by the unloaded adapter before the newly loaded adapter can generate subsequent responses to the input query.

To accelerate inferencing when a context changes and one or more adapters used in generating responses to an input correspondingly change, aspects of the present disclosure leverage batch processing techniques to allow for independent generation of a response using a baseline model (represented by the pretrained weights 140) and an adapter associated with the baseline model (represented by the adapter weights 150). To do so, a batch input 110 may be generated as the input x and a copy of the input x′. The batch input 110 may be input into the baseline model for processing using the pretrained weights W 140, resulting in an output from the baseline model of:

$$[ \begin{matrix}Wx \\ {Wx}^{′}\end{matrix} ]$$

where Wx=Wx′.

To generate the output of the adapter associated with the baseline model, a mask 120 may be established so that the output of the adapter is added to one element of the output of the baseline model, but not to both elements of the output of the baseline model. The mask 120 may be represented as the matrix:

$$[ \begin{matrix}1 \\ 0\end{matrix} ]$$

By doing so, the batch input 110 and the mask 120 may be multiplied such that the input into the adapter associated with the baseline model is represented as the matrix:

$$[ \begin{matrix}x \\ 0\end{matrix} ]$$

The input into the adapter may be processed using the adapter weights 150, and the corresponding output of the adapter associated with the baseline model may be represented as the matrix:

$$[ \begin{matrix}ABx \\ 0\end{matrix} ]$$

The output of the baseline model and the output of the adapter associated with the baseline model may be added at the addition block 160, resulting in the output:

$$[ \begin{matrix}Wx + Abx \\ Wx\end{matrix} ]$$

That is, the machine learning model 100 may be configured to generate two outputs when an adapter is used to generate a response to an input query. A first output may be the adapted output of the baseline model, and a second output may be the output of the baseline model. Because (as discussed in further detail below) the baseline model and the adapter operate in parallel to generate outputs of the machine learning model 100, key-value caches used to condition subsequent inferencing rounds using the machine learning model 100 may also be independently maintained for the baseline model and the adapter, and the key-value cache associated with the baseline model can be leveraged to provide context to a newly instantiated adapter when the context of the input query changes.

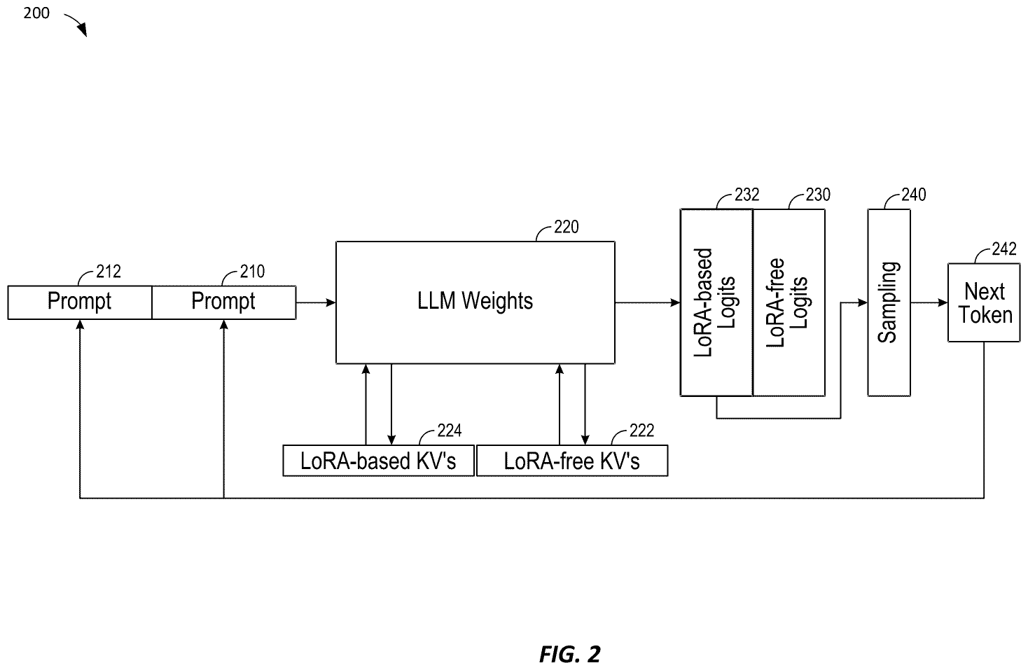

FIG. 2 illustrates an example pipeline 200 for generating a response to an input prompt using a machine learning model and adapters associated with the machine learning model, in accordance with aspects of the present disclosure.

As illustrated, to generate a response to an input prompt, an input prompt 210 and a copy of the input prompt 212 may be provided as input to a layer of a machine learning model having weights 220. As discussed above with respect to FIG. 1, the weights 220 of the machine learning model include weights W associated with a baseline version of the machine learning model and weights AB associated with an adapter used to adapt the baseline machine learning model to perform various specified tasks.

In generating an output of the machine learning model, represented by the adapter-based output 232 and the non-adapter-based output 230, the machine learning model can use key-value data in the combined cache 224 and in the baseline model cache 222 as context for generating the adapter-based output 232 and the non-adapter-based output 230, respectively. As discussed above, the non-adapter-based output 230 may be represented as Wx, while the adapter-based output 232 may be represented as Wx+ABx. The data in the combined cache 224 and the baseline model cache 222 can be updated after each round of inferencing to provide sufficient context for the generation of keys and values in the next round of inferencing.

Meanwhile, to generate a token responding to the input (represented by the input prompt 210 and the copy of the input prompt 212), tokens may be sampled at the sampling block 240 from the adapter-based output 232, but not sampled from the non-adapter-based output 230 generated by the baseline model. The tokens may be sampled at the sampling block 240 from the adapter-based output 232 because the adapter is generally configured to generate responses relevant to the input prompt 210 and the current context in which the machine learning model is operating, while the non-adapter-based output may be a more generalized output that may not be as relevant to the current context in which the machine learning model is operating. The selected token 242, which may be generated based on sampling at the sampling block 240 to identify a token that is most likely to be relevant to the input prompt, may be appended to both the input prompt 210 and the copy of the input prompt 212 for use in a subsequent round of inferencing.

Generally, because the baseline model and the adapter currently loaded for use in generating inferences for a given input into the machine learning model generate outputs independently based on the same inputs, the baseline model may maintain contextual information usable across different adapters as such adapters are loaded for use in generating inferences. It should be noted, as illustrated, sampling need not be performed on the non-adapter-based output 230, though sampling may be performed using the non-adapter-based output 230 in various circumstances, such as to allow for the generation of alternative dialogue paths. Meanwhile, the adapter-based output 232 Wx+ABx may be used to generate the response to the input query. Thus, when a new adapter is loaded for use in inferencing operations, the new adapter can leverage the key-value cache data and other contextual information previously generated by the baseline model (and stored in the baseline model cache 222) to condition the generation of a subsequent output of the machine learning model.

In some aspects, to minimize, or at least reduce, the size of the combined cache 224, the data in the combined cache 224 can be compressed based on the relationship between the key-value data in the baseline model cache 222 and the key-value data in the combined cache 224. Generally, the key-value data in the combined cache 224 is close in value to the baseline key-value data in the baseline model cache 222. Thus, the difference between the key data in the combined cache 224, K_{adapter}, and the key data in the baseline model cache 222, K, may be represented as ABx=K_{adapter}−K, where AB is a low-rank matrix. The data values V_{adapter} and V may similarly be represented. Thus, to reduce the size of the data stored in the adapter cache, the difference between K_{adapter} and K (and/or the difference between V_{adapter} and V) may be encoded prior to storage and decoded prior to use during a subsequent round of inferencing.

To compress ABx, ABx may be quantized and encoded into a compressed version. Generally, the quantization may allow for ABx to be represented using a smaller number of bits than the number of bits used to represent K_{adapter} or K, and the entropy coding generally compresses the quantized version of ABx into a compact representation. During a subsequent inferencing round, the compressed version of ABx may be decoded and dequantized prior to when ABx is to be used in computing attention in the subsequent inferencing round, and the recovered ABx (or approximation ABx′) may be added to the key-value data in the baseline model cache to recover the key-value data associated with the adapter. The recovered key-value data associated with the adapter may be used in generating key-value data for the subsequent round of inferencing and then may be discarded such that the combined cache 224 does not store uncompressed key-value data (e.g., does not store the entirety of the key-value data associated with Wx+ABx).

### Example Operations for Efficient Adaptation of a Machine Learning Model Using Baseline Model and Adapter Caches

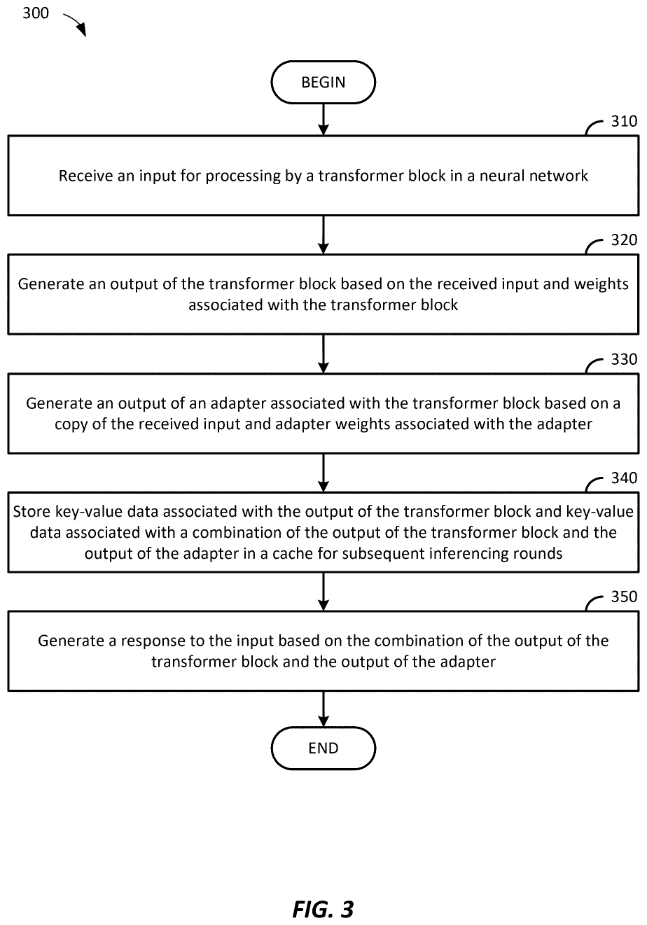

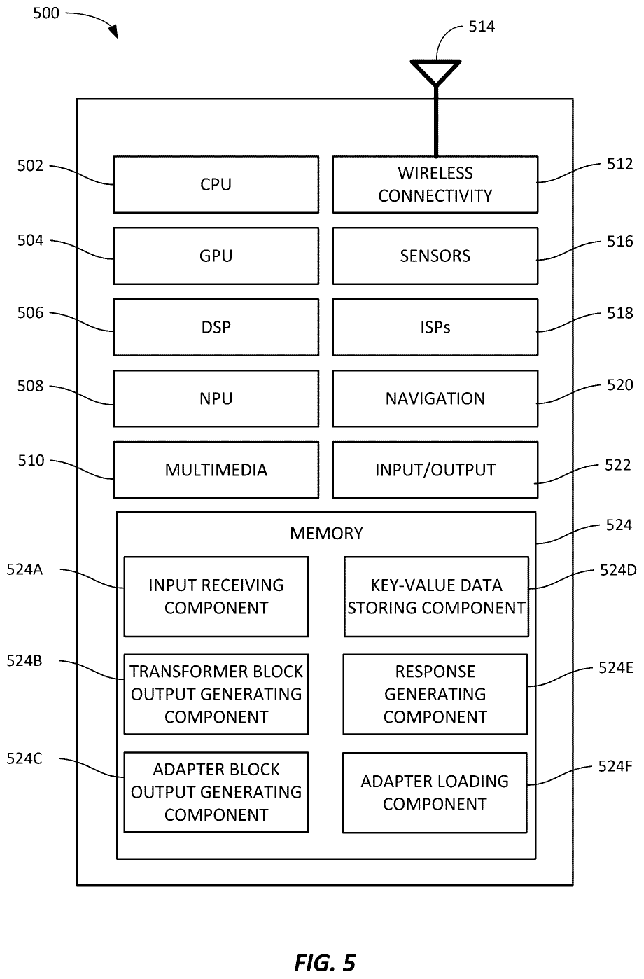

FIG. 3 shows an example of operations 300 for inferencing using a machine learning model adapted from a base model to perform a downstream task, in accordance with aspects of the present disclosure. In some examples, the operations 300 may be performed by a device, such as an example processing system 500 illustrated in FIG. 5.

As illustrated, the operations 300 begin at block 310, with receiving an input for processing by a transformer block in a neural network.

At block 320, the operations 300 proceed with generating an output of the transformer block based on the received input and weights associated with the transformer block.

At block 330, the operations 300 proceed with generating an output of an adapter associated with the transformer block based on a copy of the received input and adapter weights associated with the adapter.

In some aspects, to generate the output of the adapter associated with the transformer block, the received input and the copy of the received input may be organized into a batch. For example, as discussed, the received input x and the copy of the received input x′ may be organized into a batch represented by the matrix:

$$[ \begin{matrix}x \\ {x}^{′}\end{matrix} ]$$

A mask may be generated for the adapter. The mask generally may be defined such that the adapter generates an intermediate output (e.g., ABx) based on the received input and not the copy of the received input. For example, the mask may be represented by the matrix:

$$[ \begin{matrix}1 \\ 0\end{matrix} ]$$

A batched output may be generated as a product of the adapter weights, the batch, and the mask to generate the output of the adapter. For example, the batched output may be represented as:

$$[ \begin{matrix}Abx \\ 0\end{matrix} ] = [ \begin{matrix}x \\ {x}^{′}\end{matrix} ] \times [ \begin{matrix}1 \\ 0\end{matrix} ] \times [ \begin{matrix}AB \\ AB\end{matrix} ]$$

In some aspects, the output of a layer of the neural network including the transformer block and the adapter comprises a first output based on the received input in the batch and a second output based on the copy of the received input in the batch. For example, the output of the transformer block may be represented by the matrix

$$[ \begin{matrix}Wx \\ {Wx}^{′}\end{matrix} ]$$

To generate the output of the layer of the neural network, the output of the transformer block and the output of the adapter block (e.g., the batched output discussed above) may be added together. The output h of the layer of the neural network may thus be represented by the equation:

$$h = [ \begin{matrix}Wx \\ {Wx}^{′}\end{matrix} ] + [ \begin{matrix}Abx \\ 0\end{matrix} ] = [ \begin{matrix}Wx + Abx \\ {Wx}^{′}\end{matrix} ]$$

The output of the layer of the neural network may, in some aspects, be generated based on element-wise addition of a matrix defining the batch and a matrix defining the output of the adapter.

At block 340, the operations 300 proceed with storing key-value data associated with the output of the transformer block and key-value data associated with a combination of the output of the transformer block and the output of the adapter in a cache for subsequent inferencing rounds.

At block 350, the operations 300 proceed with generating a response to the input based on the combination of the output of the transformer block and the output of the adapter.

In some aspects, generating the response to the input generally includes sampling tokens based on the combination of the output of the transformer block and the output of the adapter. A response token may be identified based on the combination of the output of the transformer block and the output of the adapter.

In some aspects, the operations 300 further include updating the cache to include the generated response to the input, the updated cache including (1) the received input and the generated response, and (2) the copy of the received input and the generated response. A subsequent output of the transformer block may be generated based on the received input and the generated response, and a subsequent output of the adapter may be generated based on the received input and the generated response. A subsequent response to the input may be generated based on a combination of the subsequent output of the transformer block and the subsequent output of the adapter.

In some aspects, the operations 300 further include receiving a subsequent input for processing using the transformer block. A subsequent output of the transformer block may be generated based on the subsequent input, the input, and the generated response. An output of another adapter associated with the transformer block may be generated based on the subsequent input, the input, and the generated response. A response to the subsequent input may be generated based on a combination of the subsequent output of the transformer block and the subsequent output of the other adapter.

In some aspects, the operations 300 further include compressing the key-value data associated with the combination of the output of the transformer block and the output of the adapter. In a subsequent round of response generation, the keys and values associated with the combination of the output of the transformer block and the output of the adapter may be decompressed prior to processing the input and the generated response through an attention block of the transformer block. The key-value data associated with the combination of the output of the transformer block and the output of the adapter may generally include an encoded delta between the output of the transformer block and the combination of the output of the transformer block and the output of the adapter.

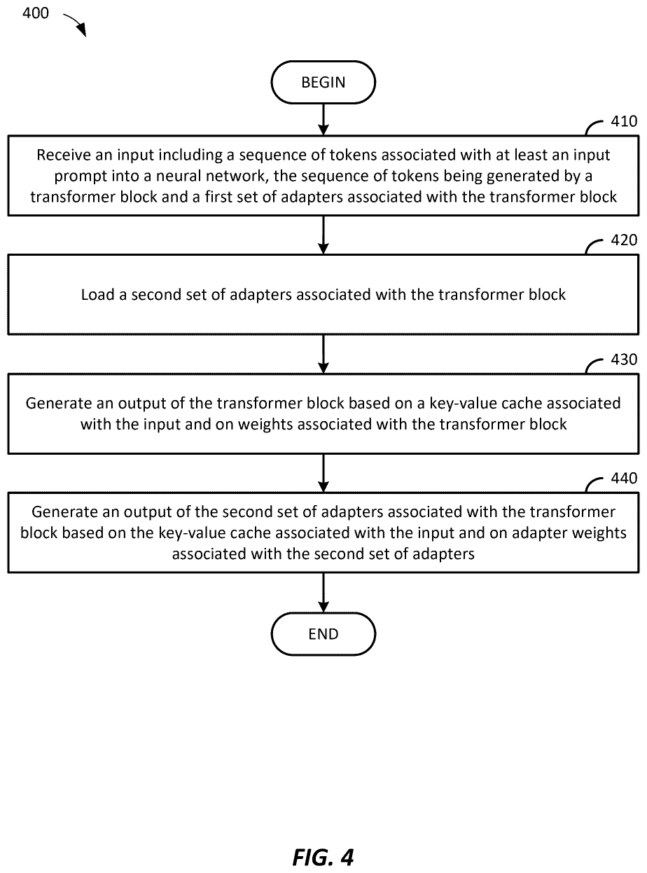

FIG. 4 shows an example of operations 400 for inferencing using a machine learning model adapted from a base model to perform a downstream task using different loadable adapters, in accordance with aspects of the present disclosure. In some examples, the operations 400 may be performed by a device, such as an example processing system 500 illustrated in FIG. 5.

As illustrated, the operations 400 begin at block 410, with receiving an input including a sequence of tokens associated with at least an input prompt into a neural network, the sequence of tokens being generated by a transformer block and a first set of adapters associated with the transformer block. In some aspects, the input further includes tokens generated by the first set of adapters in response to the input prompt in one or more previous inferencing rounds.

At block 420, the operations 400 proceed with loading a second set of adapters associated with the transformer block.

At block 430, the operations 400 proceed with generating an output of the transformer block based on a key-value cache associated with the input and on weights associated with the transformer block.

At block 440, the operations 400 proceed with generating an output of the second set of adapters associated with the transformer block based on the key-value cache associated with the input and on adapter weights associated with the second set of adapters.

In some aspects, generating the output of the second set of adapters avoids reprocessing the input prompt through the second set of adapters.

In some aspects, generating the output of the second set of adapters includes organizing the input and a copy of the input into a batch. A mask for the second set of adapters may be generated. Generally, the mask may be defined such that the adapter generates an intermediate output based on the received input and not the copy of the received input. A batched output may be generated as a product of weights of the second set of adapters, the batch, and the mask to generate the output of the second set of adapters.

In some aspects, an output of a layer of the neural network including the transformer block and the second set of adapters comprises a first output based on the output of the transformer block and a second output based on a combination of the output of the transformer block and the output of the second set of adapters.

In some aspects, the output of the layer of the neural network including the transformer block and the second set of adapters is generated based on element-wise addition of a matrix defining the batch and a matrix defining the output of the second set of adapters.

In some aspects, the operations 400 further include storing key-value data associated with the output of the transformer block and key-value data associated with a combination of the output of the transformer block and the output of the second set of adapters in the key-value cache for subsequent inferencing rounds using the neural network.

In some aspects, the operations 400 further include generating a response to the input based on the output of the second set of adapters. In generating a response to the input based on the output of the second set of adapters, tokens may be sampled based on the combination of the output of the transformer block and the output of the second set of adapters. A response token may be identified based on the combination of the output of the transformer block and the output of the second set of adapters.

In some aspects, the operations 400 further include updating the input to include key-value data associated with the generated response to the input. The updated input may include (i) the received input and the generated response and (ii) a copy of the received input and the generated response. A subsequent output of the transformer block may be generated based on the updated input and the generated response, and a subsequent output of the second set of adapters may be generated based on the updated input and the generated response. A subsequent response to the input may be generated based on a combination of the subsequent output of the transformer block and the subsequent output of the second set of adapters.

In some aspects, the operations 400 further include compressing key-value data associated with the combination of the output of the transformer block and the output of the second set of adapters. In a subsequent round of response generation, the key-value data associated with the combination of the output of the transformer block may be decompressed prior to processing the input and the generated response through an attention block of the transformer block.

In some aspects, the key-value data associated with the combination of the output of the transformer block and the output of the second set of adapters comprises an encoded delta between (i) the output of the transformer block and (ii) the combination of the output of the transformer block and the output of the second set of adapters.

### Example Processing Systems for Efficient Adaptation of a Machine Learning Model Including Loadable Adapters

FIG. 5 depicts an example processing system 500 for efficiently adapting a machine learning model to perform a downstream task different from a base task and inferencing using the adapted model using loadable adapters, such as described herein for example with respect to FIGS. 3 and 4.

The processing system 500 includes a central processing unit (CPU) 502, which in some examples may be a multi-core CPU. Instructions executed at the CPU 502 may be loaded, for example, from a program memory associated with the CPU 502 or may be loaded from a memory 524.

The processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as the NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the plurality of NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and other wireless data transmission standards. The wireless connectivity component 512 is further coupled to one or more antennas 514.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes an input receiving component 524A, a transformer block output generating component 524B, an adapter block output generating component 524C, a key-value data storing component 524D, a response generating component 524E, and an adapter loading component 524F. The depicted components, and others not depicted, may be configured to perform various aspects of the methods described herein.

Generally, the processing system 500 and/or components thereof may be configured to perform the methods described herein.

Notably, in other aspects, elements of the processing system 500 may be omitted, such as where the processing system 500 is a server computer or the like. Further, elements of the processing system 500 may be distributed, such as training a model and using the model to generate inferences, such as user verification predictions.

### EXAMPLE CLAUSES

Implementation details of various aspects of the present disclosure are described in the following numbered clauses.
Clause 1: A processor-implemented method for machine learning, comprising: receiving an input for processing by a transformer block in a neural network; generating an output of the transformer block based on the received input and weights associated with the transformer block; generating an output of an adapter associated with the transformer block based on a copy of the received input and adapter weights associated with the adapter; storing key-value data associated with the output of the transformer block and key-value data associated with a combination of the output of the transformer block and the output of the adapter in a cache for subsequent inferencing rounds; and generating a response to the input based on the combination of the output of the transformer block and the output of the adapter.
Clause 2: The method of Clause 1, wherein generating the output of the adapter associated with the transformer block comprises: organizing the received input and the copy of the received input into a batch; generating a mask for the adapter, the mask being defined such that the adapter generates an intermediate output based on the received input and not the copy of the received input; and generating a batched output as a product of the adapter weights, the batch, and the mask to generate the output of the adapter.
Clause 3: The method of Clause 2, wherein the output of a layer of the neural network including the transformer block and the adapter comprises a first output based on the received input in the batch and a second output based on the copy of the received input in the batch.
Clause 4: The method of Clause 3, further comprising generating the output of the layer of the neural network including the transformer block and the adapter based on element-wise addition of a matrix defining the batch and a matrix defining the output of the adapter.
Clause 5: The method of any of Clauses 1 through 4, wherein generating the response to the input comprises: sampling tokens based on the combination of the output of the transformer block and the output of the adapter; and identifying a response token based on the combination of the output of the transformer block and the output of the adapter.
Clause 6: The method of any of Clauses 1 through 5, further comprising: updating the cache to include the generated response to the input, the updated cache including (1) the received input and the generated response, and (2) the copy of the received input and the generated response; generating a subsequent output of the transformer block based on the received input and the generated response; generating a subsequent output of the adapter based on the received input and the generated response; and generating a subsequent response to the input based on a combination of the subsequent output of the transformer block and the subsequent output of the adapter.
Clause 7: The method of any of Clauses 1 through 6, further comprising: receiving a subsequent input for processing using the transformer block; generating a subsequent output of the transformer block based on the subsequent input, the input, and the generated response; generating an output of another adapter associated with the transformer block based on the subsequent input, the input, and the generated response; and generating a response to the subsequent input based on a combination of the subsequent output of the transformer block and the subsequent output of the other adapter.
Clause 8: The method of any of Clauses 1 through 7, further comprising: compressing the key-value data associated with the combination of the output of the transformer block and the output of the adapter; and in a subsequent round of response generation, decompressing the keys and values associated with the combination of the output of the transformer block and the output of the adapter prior to processing the input and the generated response through an attention block of the transformer block.
Clause 9: The method of Clause 8, wherein the key-value data associated with the combination of the output of the transformer block and the output of the adapter comprises an encoded delta between the output of the transformer block and the combination of the output of the transformer block and the output of the adapter.
Clause 10: A processor-implemented method for machine learning, comprising: receiving an input including a sequence of tokens associated with at least an input prompt into a neural network, the sequence of tokens being generated by a transformer block and a first set of adapters associated with the transformer block; loading a second set of adapters associated with the transformer block; generating an output of the transformer block based on a key-value cache associated with the input and on weights associated with the transformer block; and generating an output of the second set of adapters associated with the transformer block based on the key-value cache associated with the input and on adapter weights associated with the second set of adapters.
Clause 11: The method of Clause 10, further comprising storing key-value data associated with the output of the transformer block and key-value data associated with a combination of the output of the transformer block and the output of the second set of adapters in the key-value cache for subsequent inferencing rounds using the neural network.
Clause 12: The method of Clause 10 or 11, wherein the input further comprises tokens generated by the first set of adapters in response to the input prompt in one or more previous inferencing rounds.
Clause 13: The method of any of Clauses 10 through 12, wherein generating the output of the second set of adapters avoids reprocessing the input prompt through the second set of adapters.
Clause 14: The method of any of Clauses 10 through 13, generating the output of the second set of adapters comprises: organizing the input and a copy of the input into a batch; generating a mask for the second set of adapters, the mask being defined such that the adapter generates an intermediate output based on the received input and not the copy of the received input; and generating a batched output as a product of weights of the second set of adapters, the batch, and the mask to generate the output of the second set of adapters.
Clause 15: The method of Clause 14, wherein an output of a layer of the neural network including the transformer block and the second set of adapters comprises a first output based on the output of the transformer block and a second output based on a combination of the output of the transformer block and the output of the second set of adapters.
Clause 16: The method of Clause 15, wherein the output of the layer of the neural network including the transformer block and the second set of adapters is generated based on element-wise addition of a matrix defining the batch and a matrix defining the output of the second set of adapters.
Clause 17: The method of any of Clauses 10 through 16, further comprising generating a response to the input based on the output of the second set of adapters.
Clause 18: The method of Clause 17, wherein generating the response to the input comprises: sampling tokens based on the combination of the output of the transformer block and the output of the second set of adapters; and identifying a response token based on the combination of the output of the transformer block and the output of the second set of adapters.
Clause 19: The method of Clause 17 or 18, further comprising: updating the input to include key-value data associated with the generated response to the input, the updated input including (1) the received input and the generated response, and (2) a copy of the received input and the generated response; generating a subsequent output of the transformer block based on the updated input and the generated response; generating a subsequent output of the second set of adapters based on the updated input and the generated response; and generating a subsequent response to the input based on a combination of the subsequent output of the transformer block and the subsequent output of the second set of adapters.
Clause 20: The method of any of Clauses 17 through 19, further comprising: compressing key-value data associated with the combination of the output of the transformer block and the output of the second set of adapters; and in a subsequent round of response generation, decompressing the key-value data associated with the combination of the output of the transformer block prior to processing the input and the generated response through an attention block of the transformer block.
Clause 21: The method of Clause 20, wherein the key-value data associated with the combination of the output of the transformer block and the output of the second set of adapters comprises an encoded delta between the output of the transformer block and the combination of the output of the transformer block and the output of the second set of adapters.
Clause 22: A processing system comprising: a memory comprising computer-executable instructions; and one or more processors configured to execute the computer-executable instructions and cause the processing system to perform a method in accordance with any of Clauses 1 through 21.
Clause 23: A processing system comprising means for performing a method in accordance with any of Clauses 1 through 21.
Clause 24: A non-transitory computer-readable medium comprising computer-executable instructions that, when executed by one or more processors of a processing system, cause the processing system to perform a method in accordance with any of Clauses 1 through 21.
Clause 25: A computer program product embodied on a computer-readable storage medium comprising code for performing a method in accordance with any of Clauses 1 through 21.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
at least one memory having executable instructions stored thereon; and
one or more processors configured to execute the executable instructions to cause the processing system to:
receive an input for processing by a transformer block in a neural network;
generate an output of the transformer block based on the received input and weights associated with the transformer block;
generate an output of an adapter associated with the transformer block based on a copy of the received input and adapter weights associated with the adapter;
store key-value data associated with the output of the transformer block and key-value data associated with a combination of the output of the transformer block and the output of the adapter in a cache for subsequent inferencing rounds; and
generate a response to the input based on the combination of the output of the transformer block and the output of the adapter.

2. The processing system of claim 1, wherein to generate the output of the adapter associated with the transformer block, the one or more processors are configured to cause the processing system to:
organize the received input and the copy of the received input into a batch;
generate a mask for the adapter, the mask being defined such that the adapter generates an intermediate output based on the received input and not the copy of the received input; and
generate a batched output as a product of the adapter weights, the batch, and the mask to generate the output of the adapter.

3. The processing system of claim 2, wherein the output of a layer of the neural network including the transformer block and the adapter comprises a first output based on the received input in the batch and a second output based on the copy of the received input in the batch.

4. The processing system of claim 3, wherein the one or more processors are further configured to cause the processing system to:
generate the output of the layer of the neural network including the transformer block and the adapter based on element-wise addition of a matrix defining the batch and a matrix defining the output of the adapter.

5. The processing system of claim 1, wherein to generate the response to the input, the one or more processors are configured to cause the processing system to:
sample tokens based on the combination of the output of the transformer block and the output of the adapter; and
identify a response token based on the combination of the output of the transformer block and the output of the adapter.

6. The processing system of claim 1, wherein the one or more processors are further configured to cause the processing system to:
update the cache to include the generated response to the input, the updated cache including (1) the received input and the generated response, and (2) the copy of the received input and the generated response;
generate a subsequent output of the transformer block based on the received input and the generated response;
generate a subsequent output of the adapter based on the received input and the generated response; and
generate a subsequent response to the input based on a combination of the subsequent output of the transformer block and the subsequent output of the adapter.

7. The processing system of claim 1, wherein the one or more processors are further configured to cause the processing system to:
receive a subsequent input for processing using the transformer block;
generate a subsequent output of the transformer block based on the subsequent input, the input, and the generated response;
generate an output of another adapter associated with the transformer block based on the subsequent input, the input, and the generated response; and
generate a response to the subsequent input based on a combination of the subsequent output of the transformer block and the subsequent output of the other adapter.

8. The processing system of claim 1, wherein the one or more processors are further configured to cause the processing system to:
compress the key-value data associated with the combination of the output of the transformer block and the output of the adapter; and
in a subsequent round of response generation, decompress keys and values associated with the combination of the output of the transformer block and the output of the adapter prior to processing the input and the generated response through an attention block of the transformer block.

9. The processing system of claim 8, wherein the key-value data associated with the combination of the output of the transformer block and the output of the adapter comprises an encoded delta between the output of the transformer block and the combination of the output of the transformer block and the output of the adapter.

10. A processor-implemented method for machine learning, comprising:
receiving an input for processing by a transformer block in a neural network;
generating an output of the transformer block based on the received input and weights associated with the transformer block;
generating an output of an adapter associated with the transformer block based on a copy of the received input and adapter weights associated with the adapter;
storing key-value data associated with the output of the transformer block and key-value data associated with a combination of the output of the transformer block and the output of the adapter in a cache for subsequent inferencing rounds; and
generating a response to the input based on the combination of the output of the transformer block and the output of the adapter.

11. The method of claim 10, wherein generating the output of the adapter associated with the transformer block comprises:
organizing the received input and the copy of the received input into a batch;
generating a mask for the adapter, the mask being defined such that the adapter generates an intermediate output based on the received input and not the copy of the received input; and
generating a batched output as a product of the adapter weights, the batch, and the mask to generate the output of the adapter.

12. The method of claim 11, wherein the output of a layer of the neural network including the transformer block and the adapter comprises a first output based on the received input in the batch and a second output based on the copy of the received input in the batch.

13. The method of claim 12, further comprising generating the output of the layer of the neural network including the transformer block and the adapter based on element-wise addition of a matrix defining the batch and a matrix defining the output of the adapter.

14. The method of claim 10, wherein generating the response to the input comprises:
sampling tokens based on the combination of the output of the transformer block and the output of the adapter; and
identifying a response token based on the combination of the output of the transformer block and the output of the adapter.

15. The method of claim 10, further comprising:
updating the cache to include the generated response to the input, the updated cache including (1) the received input and the generated response, and (2) the copy of the received input and the generated response;
generating a subsequent output of the transformer block based on the received input and the generated response;
generating a subsequent output of the adapter based on the received input and the generated response; and
generating a subsequent response to the input based on a combination of the subsequent output of the transformer block and the subsequent output of the adapter.

16. The method of claim 10, further comprising:
receiving a subsequent input for processing using the transformer block;
generating a subsequent output of the transformer block based on the subsequent input, the input, and the generated response;
generating an output of another adapter associated with the transformer block based on the subsequent input, the input, and the generated response; and
generating a response to the subsequent input based on a combination of the subsequent output of the transformer block and the subsequent output of the other adapter.

17. The method of claim 10, further comprising:
compressing the key-value data associated with the combination of the output of the transformer block and the output of the adapter; and
in a subsequent round of response generation, decompressing keys and values associated with the combination of the output of the transformer block and the output of the adapter prior to processing the input and the generated response through an attention block of the transformer block.

18. The method of claim 17, wherein the key-value data associated with the combination of the output of the transformer block and the output of the adapter comprises an encoded delta between the output of the transformer block and the combination of the output of the transformer block and the output of the adapter.

19. A processing system for machine learning, comprising:
means for receiving an input for processing by a transformer block in a neural network;
means for generating an output of the transformer block based on the received input and weights associated with the transformer block;
means for generating an output of an adapter associated with the transformer block based on a copy of the received input and adapter weights associated with the adapter;
means for storing key-value data associated with the output of the transformer block and key-value data associated with a combination of the output of the transformer block and the output of the adapter in a cache for subsequent inferencing rounds; and
means for generating a response to the input based on the combination of the output of the transformer block and the output of the adapter.

20. The processing system of claim 19, wherein the means for generating the output of the adapter associated with the transformer block comprise:
means for organizing the received input and the copy of the received input into a batch;
means for generating a mask for the adapter, the mask being defined such that the adapter generates an intermediate output based on the received input and not the copy of the received input; and
means for generating a batched output as a product of the adapter weights, the batch, and the mask to generate the output of the adapter.
